(19) United States
(12) Patent Application Publication
(10) Pub. No.: US 2013/0255097 A1
(43) Pub. Date: Oct. 3, 2013

(54) CLOTHES TREATMENT APPLIANCE WITH CONDENSER AND CLEANING DEVICE

(71) Applicants: Ralf Bömmels, Falkensee (DE); Bernd Gemünden, Deisenhofen (DE); Jürgen Heß, Berlin (DE); Vladimir Proseanic, West Bloomfield, MI (US); Svetlana Visnepolschi, West Boomfield, MI (US)

(72) Inventors: Ralf Bömmels, Falkensee (DE); Bernd Gemünden, Deisenhofen (DE); Jürgen Heß, Berlin (DE); Vladimir Proseanic, West Bloomfield, MI (US); Svetlana Visnepolschi, West Boomfield, MI (US)

(73) Assignee: BSH BOSCH UND SIEMENS HAUSGERATE GMBH, Munich (DE)

(21) Appl. No.: 13/431,105

(22) Filed: Mar. 27, 2012

(51) Int. Cl. F26B 19/00

(52) U.S. Cl. 34/90

(57) ABSTRACT

A clothes treatment appliance includes a process air condenser and a cleaner for the process air condenser. The cleaner is adapted to direct a cleaning medium to the condenser from a direction other than from above.

### BACKGROUND OF THE INVENTION

The invention relates to a clothes treatment appliance, in particular, a clothes dryer, including a process air condenser and a cleaner for the process air condenser.

A typical clothes dryer (as such or as a washer-dryer in combination with a washing function) includes a laundry or clothes container (e.g. a rotatable clothes drum) that is connected to an air inlet and an air outlet of a process air channel. Warm air entering the clothes container via their inlet of the process channel dries the clothes or laundry. The resulting warm and wet process air leaves the clothes container through the air outlet of the process air channel and flows to a process air condenser that cools the process air. At the condenser, the process air precipitates. Thus, behind the condenser (with respect to a flow direction of the process air) the process air is cool and dry and flows to a heater that heats up the process air to be warm and dry. This warm and dry process air is then re-introduced into the clothes container via their inlet. To keep up the flow of the process air, an air blower may be used.

During the drying process, solid residues, especially fluffs and hair, are released by the clothes and are dragged along with the process air. At the condenser, the fluffs and hair etc. adhere to the precipitated drops of condensate water and at least partly stick to the condenser if the water drops drip from the condenser, typically into a condensate collector like a collection pan. To remove particles from the process air prior to the condenser, it is known to place filters into the process air channel between their outlet and the condenser. However, filters are not effective enough to separate all the particles or residue from the process air flow. Therefore, at the condenser mainly agglomerated lint (from fluff and/or hairs) can be observed even after a few drying operations. These lint agglomerations reduce the condensation effectiveness and may cause a breakdown of the condenser function over time.

For this sake the condenser is going to be rinsed in appropriate sequences. In state of the art appliances the removal of the agglomerations is realized by a cleaner issuing a water gush where the water is released from a rinsing water container above the condenser and flows through a downpipe that directs the water to the condenser.

For example, EP 2 134 896 B1 and WO 2010/102892 A1 both disclose a cleaner as described with the rinsing water container in the upper region of the drying appliance and the condenser in the lower region of the drying appliance. The rinsing water container is supplied by condensate water collected from the condenser.

EP 2 157 231 A1 describes a cleaner without a rinsing water container wherein the condensate is directly pumped into the downpipe.

The implementation of the described set-ups above is generally complex. It affords several components and is associated with considerable cost for material and assembly. Also, the water gush cannot completely clean the condenser, and typically a certain amount of lint remains.

### BRIEF SUMMARY OF THE INVENTION

It is an object of the present invention to overcome or mitigate at least some of the problems associated with the prior art and in particular to provide a clothes treatment appliance with an improved effectiveness for cleaning a condenser.

An object is achieved by a clothes treatment appliance including a process air condenser and a cleaner for the process air condenser, wherein the cleaner is adapted to direct a cleaning medium to the condenser from a direction other than from above.

This gives an advantage that fluff or other residue can be removed from the process air condenser more efficiently. The cleaner makes use of the fact that during normal operation of this condenser fluff or other residue adhering to the condenser finds itself in a stream of condensed water droplets. If the droplets do not remove the fluff it is streamlined with respect to the flow direction of the droplets and thus shows a higher resistance against removal in the flow direction than in another direction. Since typically the flow direction is top down, directing the cleaning medium to the condenser from a direction other than from above (i.e. avoiding a top down direction) the fluff can be removed more efficiently. Such a clothes treatment appliance may be realized in a particularly simple set-up. In particular, a rinsing water container in the upper region of the drying appliance and the downpipe may be dispensed with.

In an advantageous embodiment the cleaning medium is directed to the condenser from below. This effects a particularly effective residue removal since the medium is applied to the residue, in particular fluff, from a direction typically opposite to the flow direction of the condensate water. Alternatively or additionally, the cleaning medium may be directed to the condenser from the sides, from front, from behind and additionally from top.

In another advantageous embodiment the cleaning medium is water. Water as a cleaning medium has the advantage that it is readily available. The water may be a condensate or tap water. Tap water has the advantage that it is already pressurized and thus may provide a high amount of energy to the water directed to the condenser. Thus, a particularly simple cleaner may be realized.

In a further advantageous embodiment the cleaner includes a pressure generator to pressurize the water leaving the cleaner. Thus, the water can be directed (e.g. spattered, splashed, sprayed etc.) with a high velocity directly onto the condenser to yield a highly efficient residue removal.

In another advantageous embodiment the cleaner includes a pressure-tight condensate collection tank or container and a water splashing unit having a water outlet opening to direct the water to the condenser, wherein the condensate collection tank includes a condensate inlet, the condensate inlet is closable by a valve, the condensate collection tank is connected to a pressure generator, and the condensate collection tank is fluidly connected to the water splashing unit. This embodiment can be realized with few additional parts and in a compact manner.

The condensate collection tank may be filled by opening the valve so that condensate (that e.g. has been collected in a drip cup below the condenser which drip cup is fluidly connected to the condensate inlet) can flow into the condensate collection tank via the condensate inlet. The closed valve is pressure-tight. If there is condensate in the tank, the pressure generator may apply pressure to the condensate within the tank. The condensate is thus pressurized and flows to the water splashing unit where it exits via the water outlet opening in direction of the condenser. The condensate exiting the water splashing unit has a high velocity and thus a high cleaning power.

The valve may in particular be implemented as a controlled valve or a flap. The (controlled) valve enables a controlled filling of the tank while the flap is particularly easy to implement and also has low costs.

The condensate collection tank may also be filled by main water.

The water outlet opening may create one or more water jets, in particular one or more rows of water jets. The water outlet opening may include a water nozzle.

In another advantageous embodiment the water jet is static which allows a precise directing of the water onto the condenser and which is particularly easy to implement. In another embodiment the water jet is a movable water jet which allows a more uniformly distributed cleaning of the condenser.

In yet another advantageous embodiment the pressure generator includes a compressed-air device to introduce compressed-air into the condensate collection tank, wherein the compressed-air device includes a process-air tap channel that is connected to the condensate collection tank and to a process air channel in a position between a pressure side of an air blower and a drum of the clothes treatment appliance. In this case, the pressure created in the process air channel by the blower can be used to pressurize the condensate collection tank and thus the water within the tank. The tank may be relatively large since the blower may be a constant source of pressure. In particular, with a large tank it is advantageous that the condensate collection tank is fluidly connected to the water splashing unit by a fluid line that connects to the tank at or near its bottom to provide a high volume of water to the water splashing unit.

The process-air tap channel may be connected to the process air channel by a bypass flap.

There may be dry air or may be wet air, e.g. steam or air mixed with steam.

Alternatively, the tank may be pressurized by a dedicated compressed-air generator or by main water.

Particularly in this case it is advantageous that the process-air tap channel (or any other channel that delivers direct pressure (from steam, compressed air etc.) to the tank) is connected to the top or a region near the top of the condensate collection tank while the condensate collection tank is fluidly connected to the water splashing unit by a fluid line connected to the bottom or a region near the bottom of the tank. This reduces the probability that gas is introduced into the fluid line connected to the water splashing which would greatly reduce water pressure at the water splashing unit.

In another advantageous embodiment the condensate collection tank includes a movable wall section and the pressure generator includes a mover for moving the movable wall section into the direction of the condensate collection tank. This embodiment has an advantage that the water within the tank can be put under high pressure so that the velocity of the water hitting the condenser is very high and thus cleaning power is very good. To this effect it is advantageous that the water tank is nearly or completely filled with water when the mover starts to move the movable wall in order to avoid a pressure loss due to a compression of resident air. It is another advantage of this embodiment that it allows for a strict separation (avoids mixing) of the water within the tank from the pressurized medium/pressurizer medium, in particular main water.

In a further advantageous embodiment the movable wall section is a membrane and the mover deforms the membrane by pressure. The embodiment incorporating the membrane can be constructed rather simply. The membrane may be deformed by outside pressure (i.e. pressure applied to the outer side of the membrane while the inner side contacts the water). The outside pressure may be pressurized (dry or wet) air, water and so on without limitation.

Alternatively, the movable wall section is a piston and the mover moves the piston. The embodiment incorporating the piston may apply a particularly high pressure to the tank. In particular, the piston may be operated or moved by a mechanical device like a motor or by pressurized medium like pressurized water (hydraulic medium in general) or air (pneumatic medium in general).

In general, another intermediate pressure transmitter than a membrane or a piston may be used.

In advantageous embodiment the pressure generator includes a direct water pressurizer. A direct water pressurizer may in particular be a unit that includes a water inlet and a water outlet and wherein water leaving the outlet has a higher pressure, energy and/or velocity than the water at the inlet. In contrast to the pressure generators using the water tank, the direct water pressurizer does not need a tank and, thus, may be very compact. The ‘direct’ water pressurizer, thus, does not need an additional unit to create pressurized water to be splashed onto the condenser, e.g. via the water splashing unit.

The direct water pressurizer may in particular include a pump, e.g. a conventional pump (like a rotor pump, a membrane pump, a screw pump etc.) or an ejector pump. A driving medium for the ejector pump may include bypassed process air, compressed air, steam and so on.

In yet another advantageous embodiment, the cleaner includes an impeller rotatable around a horizontal or a vertical axis, where the impeller is partly immersed in water. This embodiment enables splashing of water onto the condenser by a rotating impeller which may be of a simple construction and, e.g., does not need a pressurization of the water.

In particular, in the case of an impeller rotatable around a horizontal axis it is advantageous that only a lower part of the impeller (in particular below the axis of rotation) is submersible in the water. This enables fast rotation of the impeller and thus a high velocity of the water being sprayed, splashed etc. from the impeller onto the condenser.

For advantageously splashing a large part of the condenser, the impeller may be located below the condenser.

It is advantageous that the impeller is partly submersible in condensate (water) of a condensate collector.

In particular if the axis of rotation is a horizontal axis (parallel to a water surface) the impeller may side-slip water picked up from the water it is immersed in to principally any region of the condenser. The shape of impeller shovels or impeller blades may be plane or curved. Advantageously for a thorough splashing, cooling blades of the condenser are oriented parallel to the direction of the water motion.

In particular if the axis of rotation is a vertical axis (perpendicular to a water surface), the lower part of all rotor blades or impeller blades is immersed within the water. The impeller blades are formed such that they move the water to their upper edges from where the water is splashed upward, in particular with a substantially perpendicular direction or momentum. The impeller may side-slip water picked up from the water it is immersed in to principally any region of the condenser unit.

The splashing can be intensified by blades that include laterally expanding grooves. During operation of the impeller, water follows the grooves due to centrifugal force. Furthermore, these grooves may provide a more uniform distribution of the splash etc. water at the condenser.

In another advantageous embodiment the condenser is submergible in water for cleaning operation of the condenser, the cleaner is located below the condenser, and the cleaner includes an air bubble generator. While the condenser is immerged in water, the bubbles released into the water by the air bubbles flow upwards through the condenser, in particular, along the condenser blades or any other surface exposed to the bubbles. Residue is exposed to a shearing motion introduced by the moving water and the bubbles which can remove the residue. This embodiment has the advantage that a particularly thorough cleaning of the condenser is possible since the air bubbles create a strong shear stress at the lint.

The removal or cleaning power is particularly strong if the air bubbles can introduce an air lift effect between adjacent surfaces of the condenser, e.g. two cooling blades. The adjacent surfaces of the condenser are then part of a water channel in which the air bubbles are rising. By their lift effect, the water is torn upward by the air bubbles and creates an additional current that serves to remove the residue.

The air bubble generator may include an array or grid of air (outlet) openings. For thorough cleaning of the condenser, the array advantageously expands below the full (projected or cross-sectional) area of the condenser (or rather its to be cleaned surface, in particular its surface exposed to the process air).

It is also advantageous for maintaining a strong air lift effect that the condenser is closed at its sides such that their lift effect is particularly effective. In particular, the housing may close an open (lateral) side between two adjacent cooling blades thus creating a laterally closed channel. If a gap exists between the housing and the side edges of the cooling blades, this gap should not substantially exceed a distance between two adjacent or neighboring cooling blades.

For a thorough cleaning of the condenser it is advantageous that the condenser is fully submerged during cleaning operation.

In an advantageous embodiment the condenser includes cooling blades that have a roof-shaped upper edge. This enables flowing down of residue lighter than water from the upper edges of the cooling blades when the water level is lowered at the end of a cleaning process.

In another advantageous embodiment the clothes treatment appliance is adapted to perform repeated cleaning cycles within one cleaning process. This further improves a cleaning effectiveness or efficiency.

Generally, if the same water is used for more than one cleaning cycle or process, it is advantageous to remove residue in the water, e.g. by filtering, between two consecutive cleaning cycles and/or cleaning processes.

In yet another advantageous embodiment, the clothes treatment appliance is a clothes drying apparatus. The clothes drying apparatus may, e.g., be a clothes dryer or a washer-dryer.

The clothes treatment appliance may be a household appliance.

### BRIEF DESCRIPTION OF THE DRAWINGS

In the figures of the attached drawings, exemplary embodiments of the invention are schematically described in more detail. Same or functionally equivalent elements may be denoted by the same reference numerals. In particular,

FIG. 1 is a sketch of a household drying appliance 11 including a process air condenser 16 and a cleaner 20 for the process air condenser 16 using water as the cleaning medium in a sectional side view;

FIG. 2 is a sketch of another embodiment of the cleaner 31 in a sectional side view;

FIG. 3 is a sketch of yet another embodiment of the cleaner 41 in a sectional side view;

FIG. 4 is a sketch of even another embodiment of the cleaner 51 in a sectional side view;

FIG. 5 is a sketch of yet another embodiment of the cleaner 61 using an impeller 62 in a sectional side view;

FIG. 6 is a sketch of even another embodiment of the cleaner 71 using another impeller 75 in a sectional side view;

FIG. 7 is a more detailed sketch of the impeller 75 of FIG. 6;

FIG. 8 is a sketch of yet another embodiment of the cleaner 81 using air as a cleaning medium in a sectional side view;

FIG. 9 is another sectional side view a sketch of air bubbles B between cooling blades 17 of a condenser 16 of FIG. 8; and

FIG. 10 is a sketched cut-out of the cooling blades 17 of a condenser 16 of FIG. 8 in a more detailed view on an upper edge of the cooling blades.

### DETAILED DESCRIPTION OF EXEMPLARY EMBODIMENTS OF THE PRESENT INVENTION

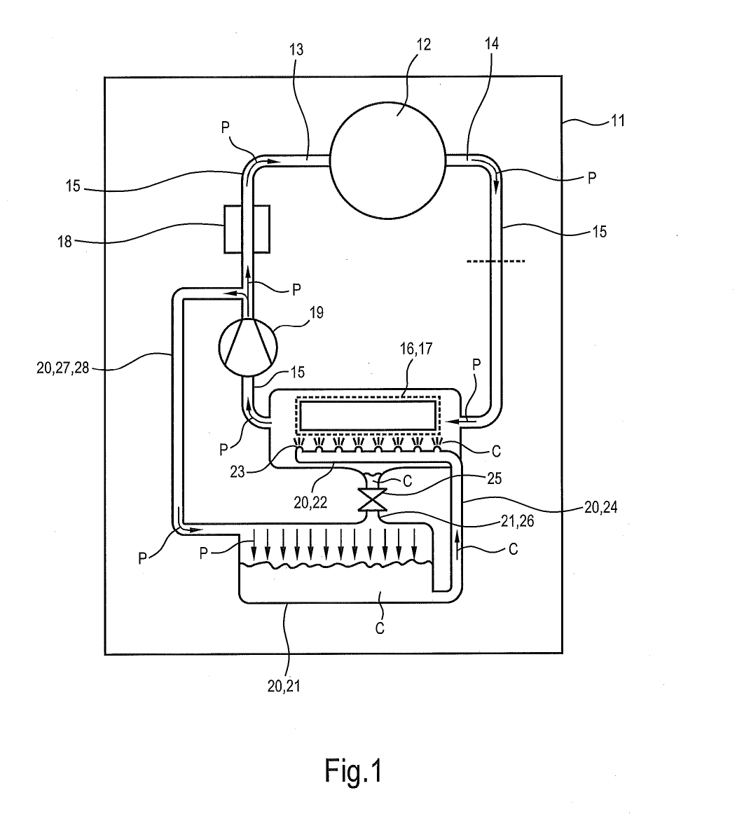

FIG. 1 shows a clothes treatment appliance realized as a household drying appliance 11, in particular a clothes dryer. The drying appliance 11 includes a clothes container in the form of a rotatable clothes drum 12. The drum 12 is connected to an air inlet section 13 and an air outlet section 14 of a process air channel 15. Warm air entering the drum 12 via the inlet section 13 can dry the clothes contained in the drum 12. The resulting warm and wet process air P leaves the drum 12 through the outlet section 14 and flows to a process air condenser 16 that cools the process air P. Thus, at the condenser 16, the process air precipitates. To cool the process air P, the condenser 16 has several plate-like cooling blades 17 that are arranged in a parallel fashion (which in the shown drawing are oriented in parallel to and are spaced apart perpendicular to the viewing plane).

The condenser 16 and its cooling blades 17, respectively, may be water-cooled. In this case, the condenser may be embodied as a water/air heat exchanger. Alternatively, the process air condenser 16 may be an evaporator of a heat pump, e.g. a compressor-type heat pump.

Behind or downstream the condenser 16, the process air P is cool and dry and flows to a heater 18 that heats up the process air P to be warm and dry. The heater 18 may be, e.g., an electric heater, or a condenser of a heat pump.

This warm and dry process air P is then re-introduced into the drum 12 via the inlet section 13. To keep up the flow of the process air P, an air blower 19 is used.

The drying appliance 11 further includes a cleaner 20 to clean the process air condenser 16 from lint (fluff, hair etc.). The cleaner 20 includes a pressure-tight condensate collection tank 21 and a water splashing unit 22. The water splashing unit 22 includes several water outlet openings 23 and is fluidly connected to the tank 21 via a fluid pipe 24. The fluid pipe 24 connects to a bottom or bottom region of the tank 21 to avoid being filled with air. Thus, by pressing condensate (water) C through the fluid pipe 24, the condensate C flows to the water splashing unit 22 and is forced through the water outlet openings 23 with a high momentum to create sprays or splash jets of condensate/water to clean the condenser 16 from lint. For a particularly high effectiveness, the water splashing unit 22 extends at least substantially over the area below the condenser 16 and its cooling blades 17, respectively. The position of the water splashing unit 22 below the condenser 16 effects a particularly effective removal of the lint.

To fill the tank 21, it is located below a section of the process air channel 15 which contains the condenser 16 and that also acts as a condensate collector. The tank 21 is connected to a bottom of this condensate collection section of the process air channel 15 via a valve 25 which, when open, allows a flow of condensate from the condensate collection section to a condensate inlet 26 of the tank 21 and which, when closed, provides a pressure-tight seal.

To press the condensate C through the fluid pipe 24, the cleaner 20 also includes a pressure generator 27 to pressurize the condensate C in the tank 21 and thus the condensate C leaving the cleaner 20 by being forced through the water outlet openings 23. The pressure generator 27 includes a process-air tap channel 28 that on one end is connected to a top or top region of the tank 21 and that on the other end is connected to the process air channel 15 in a position between a pressure side of their blower 19 and a drum of the clothes treatment appliance. The tap channel 28 taps into the process air channel 15 and allows pressurized process air P to the tank 21. The pressure generator 27 may include a not pressure-tight flap (not shown) at the process air channel end of the tap channel 28. Therefore, pressurized process air P pressurizes the tank 21 and thus the condensate. In one mode of operation, the spray of condensate C being emitted from the water outlet openings 23 is maintained as long as there is condensate C in the tank 21. If the tank runs empty, process air C is pushed through the water outlet openings 23. In another mode of operation, the tap channel 28 may be controllably closed, e.g. by another valve, to prohibit a build-up in pressure within the tank 21 outside a cleaning cycle or process.

Alternatively, the pressure in the tank 21 may be provided by steam, compressed air (e.g. provided by a dedicated air compressor), and/or pressurized water, e.g. main water (in which case the tank should be free of air during cleaning cycles.

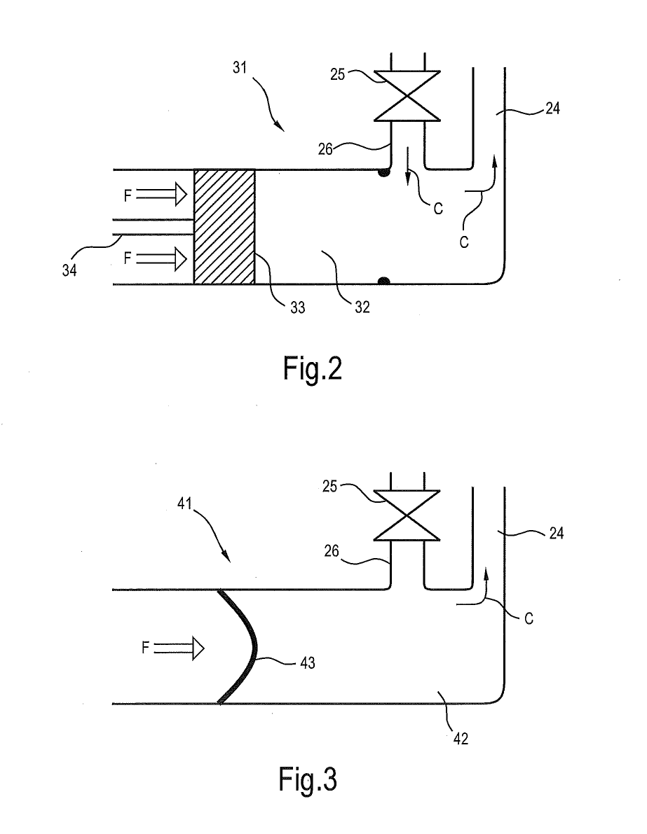

FIG. 2 shows a cleaner 31, e.g., to be used with the drying appliance 11 instead of the cleaner 20. The cleaner 31 includes a condensate collection tank 32 which may in particular be smaller than the condensate collection tank 21. Also, the condensate collection tank 32 includes a movable wall section which here is a piston 33 as an intermediate pressure transmitter. The cleaner 31 further includes a pressure generator including a mover for moving the piston 33 into the direction of the tank 32 during a cleaning cycle (and back after the cleaning). The mover may include a source of pressurized gas (e.g. air, steam and so on) or fluid (e.g. main water) on the side opposite to the tank 32 to exert a force F on the piston 33. Alternatively, the mover may, as shown, include a mechanical device for exerting a force F or pressure to the piston 33 like an actuator, an electric motor and so on, e.g. by connecting the mover to the piston 33 via a rod 34. By moving the piston 33, the condensate within the tank 32 gets pressurized and is forced through the fluid pipe 24.

FIG. 3 shows another cleaner 41, e.g. to be used with the drying appliance 11 instead of the cleaner 20 or 31. The cleaner 41 differs from the cleaner 31 in that the movable wall section of the tank 42 is a membrane 43. Accordingly, it is advantageous that the mover includes a source of pressurized gas (e.g. air, steam and so on) or fluid (e.g. main water) on the side opposite to the tank 32 to exert a force F on the membrane. By such a provision of pressure, the membrane 43 deforms in the direction of the tank 42 and pressurizes the condensate within the tank 42.

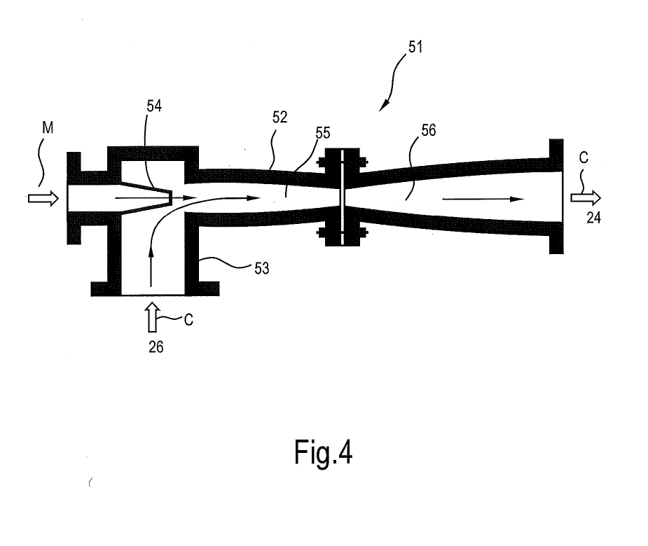

FIG. 4 shows a direct water pressurizer or accelerator in form of an ejection pump 52 of a ‘pressure’ generator of yet another cleaner 51. Here water (e.g. condensate C) to be accelerated enters an inlet 53 and is accelerated by motive fluid M (e.g. air, steam etc.) being injected via a nozzle 54. The thus accelerated water C passes a converging inlet nozzle 55 and a diverging outlet nozzle 56 before it is injected into the fluid pipe 24, for example, or directly sprayed onto the condenser 16.

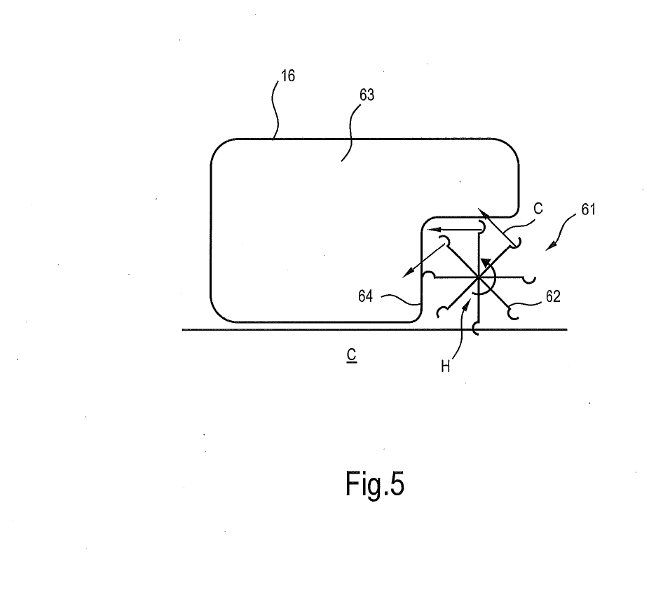

FIG. 5 shows a sketch of yet another embodiment of a cleaner 61 using an impeller 62. The impeller 62 is rotatable around a horizontal axis H, as indicated by the curved arrow. The impeller 62 is partly immersed in condensate C collected by a collection pan (not shown) etc. The collection pan may be merged with the condenser 16. Splashing of cooling blades 63 with water is effected by a fast enough rotation of the impeller 62 such that the impeller 62 can side-slip the water/condensate C into any position of the condenser 16. The cooling blades 63 are oriented parallel to the motional direction of the condensate C. The shape of the impeller shovels can be plane or curved, as shown. To maintain a particularly compact design, the blades 63 have a bottom-sided clearance 64 for at least partially accommodating the impeller 62.

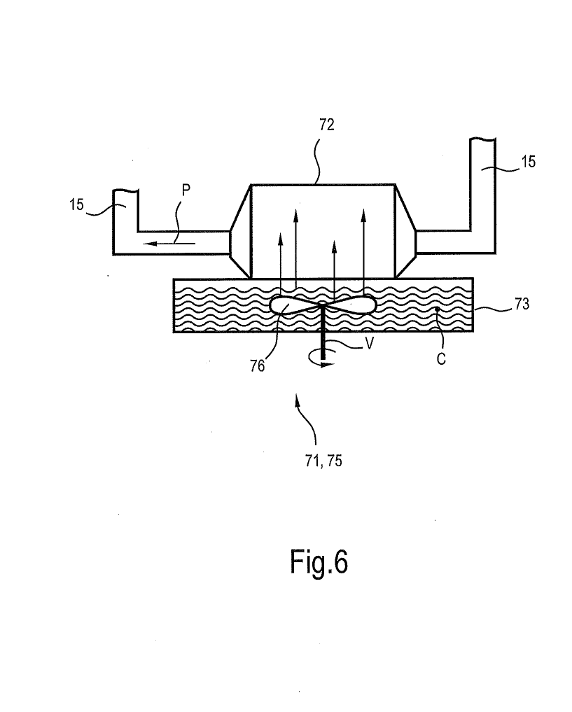

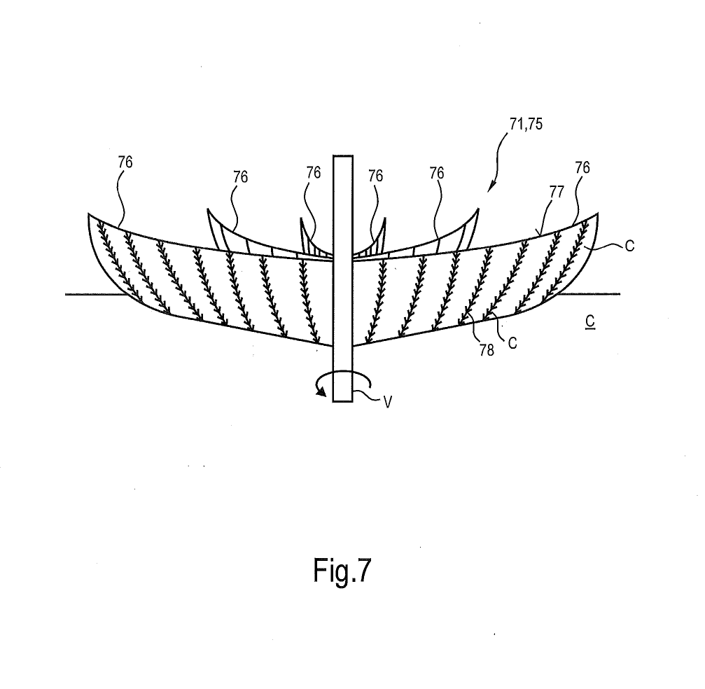

FIG. 6 shows a cut-out of a possible variation of the drying appliance 11 having a condenser 72 that is placed above a condensate collector, e.g. a condensate collection pan 73. A cleaner 71 includes an impeller 75 rotatable around a vertical axis V which is perpendicular to a surface of the condensate C. A lower part of the blades 76 of the impeller 75 is immersed in the condensate C to collect it, as also seen in FIG. 7.

The blades 76 move the condensate C to an upper edge 77 and to provide a perpendicular momentum. Then, splash water/condensate C is side-slipped into the condenser 72. This effect is enhanced by laterally expanding grooves 78 on the blades 76. During a rotation of the impeller 75, the water/condensate C follows these grooves 78 due to centrifugal force. Furthermore, these grooves 78 may provide a more uniform distribution of the splash water in the condenser 72.

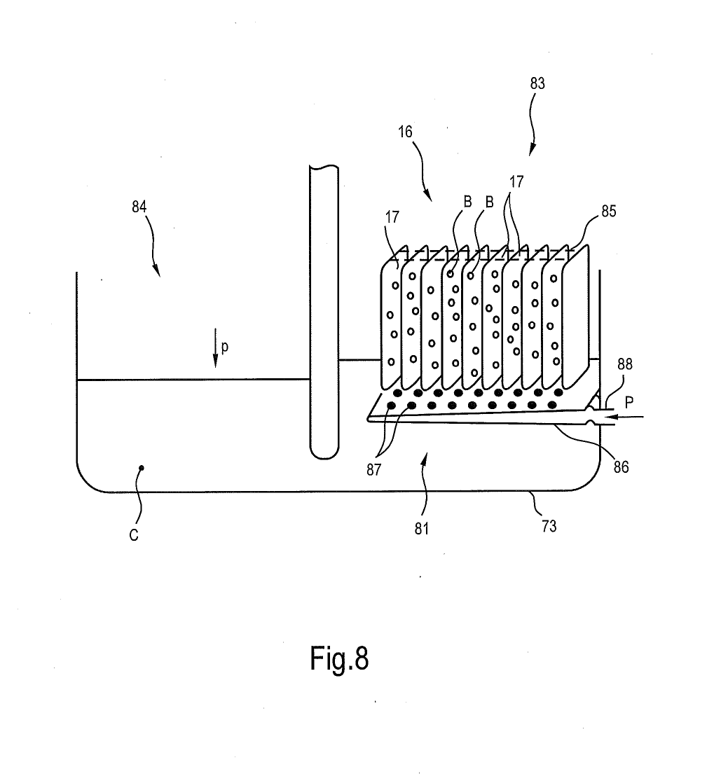

FIG. 8 shows another possible variation of the drying appliance 11 having a cleaner 81 using air as a cleaning medium. To this effect, the condenser 16 is submergible in water, e.g. condensate C, for its cleaning. A controlled submersion (i.e. raising a water level such that the condenser 16 is submerged in the water) can be realized e.g. by the principle of the communicating tubes, placing the condenser in one of the tubes 83 and applying controlled pressure p to the other tube 84 not containing the condenser 16. Alternatively, e.g. a piston or a membrane in a closed vessel can be used to control the water level.

It is advantageous for a thorough cleaning of the condenser 16 that the water level may be raised above a lowest point of the upper edges 85 of the cooling blades 17.

The cleaner 81 is located below the condenser 16 and includes an air bubble generator 86 covering its cross-section. The air bubble generator 86 includes an array or grid of air (outlet) openings 87 and an inlet 88 for introducing pressurized gas (e.g. air, in particular process air P).

For thorough cleaning of the condenser, the array advantageously expands below the full (projected) area of the condenser (or rather its surface to be cleaned, in particular its surface exposed to the process air, i.e. the cooling blades 17).

When the condenser 16 is submerged in the water/condensate C, it releases air bubbles A that flow upwards through the cooling blades 17 of the condenser 16. Lint adhering to the condenser 16 is exposed to a shearing motion introduced by the moving water and the air bubbles which can remove the residue (thus one may also consider the air bubbles and the water in combination as being the cleaning medium).

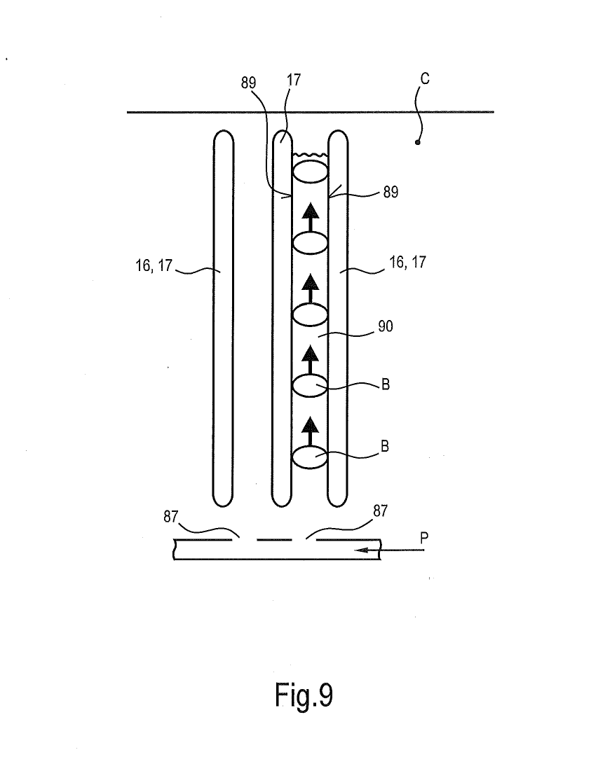

The removal or cleaning power is particularly strong since the air bubbles B can introduce an air lift effect between adjacent surfaces of neighboring cooling blades 17, as shown in FIG. 9. Adjacent surfaces 89 of the neighboring cooling blades 17 are then part of a water channel 90 in which the air bubbles B are rising. By the lift effect, the water/condensate C is torn upward by the air bubbles B and creates an additional current that serves to remove the lint.

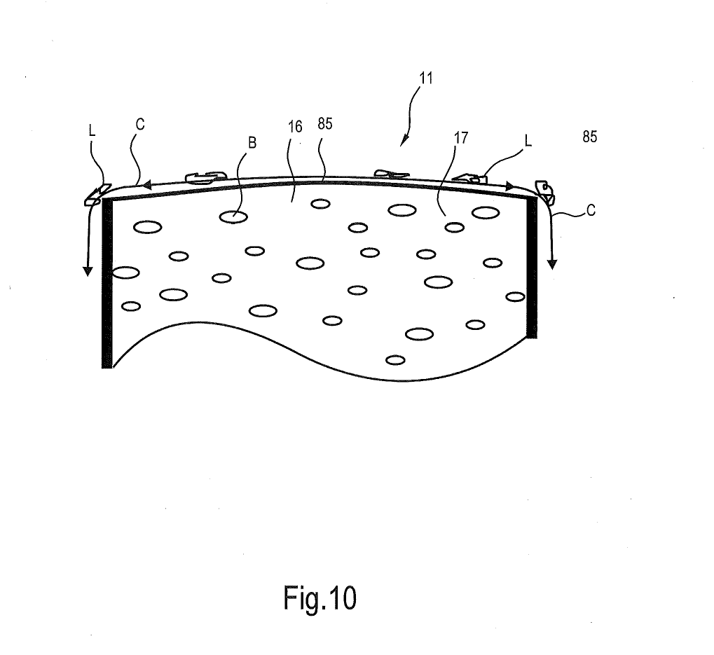

FIG. 10 shows a cut-out of the cooling blades 17 of a condenser 16 of FIG. 8 and FIG. 9 in a more detailed view of the upper edge 85 of a cooling blade 17. The upper edge 85 is roof-shaped. This enables flowing down of lint L etc. lighter than water from the upper edges 85 when the water level is lowered at the end of a cleaning process and thus inhibits adherence of lint at the upper edges 85.

Lint or other residues which are specifically heavier than water will sink to the bottom of the condensate collection pan 73 and may be removed e.g. by pumping and a drainage system.

Of course, the present invention is not limited to the described embodiments.

What is claimed is:

1. A clothes treatment appliance, comprising:
a process air condenser; and
a cleaner for the process air condenser, wherein the cleaner is adapted to direct a cleaning medium to the condenser from a direction other than from above.

2. The clothes treatment appliance of claim 1, wherein the cleaning medium is directed to the condenser from below.

3. The clothes treatment appliance of claim 2, wherein the cleaning medium is water.

4. The clothes treatment appliance of claim 3, wherein the cleaner comprises a direct water pressurizer.

5. The clothes treatment appliance of claim 3, wherein the cleaner comprises an impeller rotatable around a horizontal or a vertical axis, and the impeller is partly immersed in water.

6. The clothes treatment appliance of claim 1, wherein the cleaner comprises a pressure generator to pressurize the water leaving the cleaner.

7. The clothes treatment appliance of claim 6, wherein the cleaner comprises:
a pressure-tight condensate collection tank or container; and
a water splashing unit having a water outlet opening to direct the water to the condenser, wherein the condensate collection tank includes a condensate inlet that is closable by a valve, the condensate collection tank is connected to the pressure generator, and the condensate collection tank is fluidly connected to the water splashing unit.

8. The clothes treatment appliance of claim 7, wherein the pressure generator comprises a compressed-air device to introduce compressed-air into the condensate collection tank, wherein the compressed-air device comprises a process-air tap channel that is connected to the condensate collection tank and to a process air channel in a position between a pressure side of an air blower and a drum of the clothes treatment appliance.

9. The clothes treatment appliance of claim 7, wherein the condensate collection tank comprises a movable wall section and the pressure generator comprises a mover for moving the movable wall section into the direction of the condensate collection tank.

10. The clothes treatment appliance of claim 9, wherein the movable wall section is a membrane and the mover deforms the membrane by pressure.

11. The clothes treatment appliance of claim 9, wherein the movable wall section is a piston and the mover moves the piston.

12. The clothes treatment appliance of claim 2, wherein the condenser is submergible in water for cleaning operation of the condenser, and the cleaner is located below the condenser and comprises an air bubble generator.

13. The clothes treatment appliance of claim 12, wherein the condenser comprises cooling blades that have a roof-shaped upper edge.

14. The clothes treatment appliance of claim 1, wherein the clothes treatment appliance is adapted to perform repeated cleaning cycles within one cleaning process.

15. The clothes treatment appliance of claim 1, wherein the clothes treatment appliance is a clothes drying apparatus.
